(19) United States
(12) Patent Application Publication
(10) Pub. No.: US 2026/0204164 A1
(43) Pub. Date: Jul. 16, 2026

(54) FLIGHT PLAN MANAGEMENT DEVICE, FLIGHT PLAN MANAGEMENT METHOD, AND RECORDING MEDIUM

(71) Applicant: NEC Corporation, Tokyo (JP)

(72) Inventor: Shinji NAKADAI, Tokyo (JP)

(73) Assignee: NEC Corporation, Tokyo (JP)

(21) Appl. No.: 19/136,954

(22) PCT Filed: Dec. 16, 2022
(86) PCT No.: PCT/JP2022/046360

§ 371 Date: Jun. 9, 2025

(51) Int. Cl. G08G 5/34

(52) U.S. Cl. CPC G08G 5/34

(57) ABSTRACT

The device information acquisition means acquires device information of a mobile unit. The preparation state acquisition means acquires a preparation state of an operator. The available departure time prediction means predicts an available departure time of the mobile unit based on the device information and the preparation state. The flight plan management means manages a flight plan based on prediction results.

### TECHNICAL FIELD

This disclosure relates to management of operation plans for mobile units.

### BACKGROUND ART

In order to fly drones, it is necessary to reserve a spatiotemporal space (three-dimensional space and time) to be used. Therefore, due to uncertainties in a drone's flight plan, if the spatiotemporal space to be used cannot be determined, a larger reservation frame as a buffer may be allocated. However, allocating a larger reservation frame reduces spatial utilization efficiency, which is undesirable from a public perspective. On the other hand, if a smaller reservation frame is allocated, rebooking will be required when there are changes in the flight plan, which can be cumbersome. Patent Document 1 describes that a flight plan for flying an unmanned aerial vehicle can be submitted quickly and easily.

### PRECEDING TECHNICAL REFERENCES

### Patent Document

Patent Document 1: Japanese Patent Application Laid-Open under No. 2014-040231

### SUMMARY

### Problem to be Solved by the Invention

However, even with the method of Patent Document 1, it is not always possible to flexibly deal with a change in the flight plan.

One object of the present disclosure is to provide a flight plan management system that adjusts the spatiotemporal space to be used according to the pre-flight preparation conditions.

### Means for Solving the Problem

According to an example aspect of the present disclosure, there is provided a flight plan management device, comprising:
a device information acquisition means configured to acquire device information of a mobile unit;
a preparation state acquisition means configured to acquire a preparation state of an operator;
an available departure time prediction means configured to predict an available departure time of the mobile unit based on the device information and the preparation state; and
a flight plan management means configured to manage a flight plan based on prediction results.

According to another example aspect of the present disclosure, there is provided a flight plan management method comprising:
acquiring device information of a mobile unit;
acquiring a preparation state of an operator;
predicting an available departure time of the mobile unit based on the device information and the preparation state; and
managing a flight plan based on prediction results.

According to a further example aspect of the present disclosure, there is provided a recording medium recording a program, the program causing a computer to perform a process comprising:
acquiring device information of a mobile unit;
acquiring a preparation state of an operator;
predicting an available departure time of the mobile unit based on the device information and the preparation state; and
managing a flight plan based on prediction results.

### Effect of the Invention

According to the present disclosure, it is possible to adjust the spatiotemporal space to be used according to the pre-flight preparation conditions.

### BRIEF DESCRIPTION OF THE DRAWINGS

FIG. 1 illustrates an overall configuration of a flight plan management system according to a first example embodiment.

FIG. 2 is a block diagram illustrating a hardware configuration of a terminal device.

FIG. 3 is a block diagram illustrating a hardware configuration of a server.

FIG. 4 is a block diagram illustrating a functional configuration of the server.

FIG. 5 illustrates an example of an input screen of device information and a flight plan.

FIG. 6 illustrates an example of an input screen of a preparation state.

FIG. 7 illustrates an example of a flight plan.

FIG. 8 illustrates an example of adjustment of the flight plan.

FIG. 9 illustrates another example of adjustment of the flight plan.

FIG. 10 illustrates another example of adjustment of the flight plan.

FIG. 11 illustrates a display example of the flight plan after adjustment transmitted by the server.

FIG. 12 is a flowchart of a flight plan adjustment process.

FIG. 13 is a block diagram illustrating a functional configuration of a flight plan management device of a second example embodiment.

FIG. 14 is a flowchart of a process by the flight plan management device of the second example embodiment.

### EXAMPLE EMBODIMENTS

### First Example Embodiment

### [Overall Configuration]

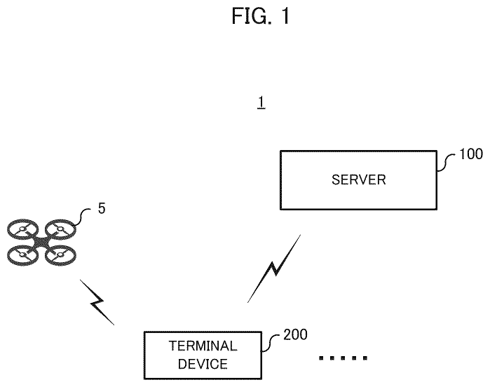

FIG. 1 shows an overall configuration of a flight plan management system to which a flight plan management device according to the present disclosure is applied. The flight plan management system 1 includes a drone 5, a server 100, and a terminal device 200. The server 100 is an example of a flight plan management device. The server 100 and the terminal device 200 can communicate wirelessly or wired. Further, the terminal device 200 and the drone 5 can communicate wirelessly. Further, it is assumed that a plurality of terminal devices 200 and a plurality of drones 5 are present.

The terminal device 200 is operated by an operator of the drone. Device information, a flight plan and a preparation state of the drone 5 are input into the terminal device 200. The device information refers to information about the drone 5 itself, including details such as its model type. The device information is transmitted from the drone 5 to the terminal device 200. The flight plan also refers to a flight plan for the drone 5, and includes information such as departure time and flight route. The operator registers the flight plan in advance on the server 100 as a reservation for a spatiotemporal space to be used. The preparation state refers to information indicating pre-flight status of the drone 5, including details such as inspection status and cargo loading condition of the drone 5. The flight plan and preparation state are input by the operator to the terminal device 200.

The server 100 manages the flight plan of the plurality of drones in a database. The server 100 also predicts an available departure time of the drone and adjusts the flight plan. The available departure time refers to a time point at which pre-flight preparations of the drone are completed and the drone is in a state ready for departure. Specifically, the server 100 receives information such as the device information, the flight plan and the preparation state of the drone 5 from the terminal device 200. The server 100 predicts the available departure time of the drone 5 using a prediction model prepared in advance. If the predicted available departure time differs from the departure time of the flight plan, the server 100 modifies the contents of the flight plan and updates the database. The server 100 discloses the updated database contents to other operators. The server 100 also transmits the modified flight plan to the terminal device 200.

Now, the prediction model will be described. The prediction model is information representing a relationship between explanatory variables and target variables. The prediction model is a component configured to estimate an outcome of an estimation target by calculating the target variable based on the explanatory variables.

The prediction model is generated by executing a learning algorithm using training data, in which values of the target variable are already obtained, and arbitrary parameters as inputs. The prediction model may be, for example, a function “c” that maps an input “x” to a correct output “y.” The prediction model may be configured to estimate a numerical value of the estimation target, or to estimate a label of the estimation target. The prediction model may output a variable describing a probability distribution of the target variable. The prediction model may also be referred to as a “learning model,” “analysis model,” “AI model,” “trained model,” “inference model,” or “prediction formula.”

The explanatory variables are variables used as inputs in the prediction model. The explanatory variables may also be referred to as a “feature value” or simply a “feature.”

Further, the learning algorithm for generating the prediction model is not particularly limited, and may be any existing learning algorithm. For example, the learning algorithm may be a random forest, a support vector machine, a naive Bayes method, a neural network, a piecewise linear model using FAB inference (Factorized Asymptotic Bayesian Inference), or a neural network.

The method of the piecewise linear model using FAB inference is disclosed, for example, in U.S. Patent Application Publication No. US2014/0222741A1.

Also, the prediction model is not limited to those generated by learning algorithms. The prediction model may be a model that predicts the available departure time based on predetermined rules.

In this way, the server 100 predicts the available departure time and adjusts the reservation frame of the spatiotemporal space, so that the operator can concentrate on the pre-flight preparations.

### [Hardware Configuration]

### (Terminal Device)

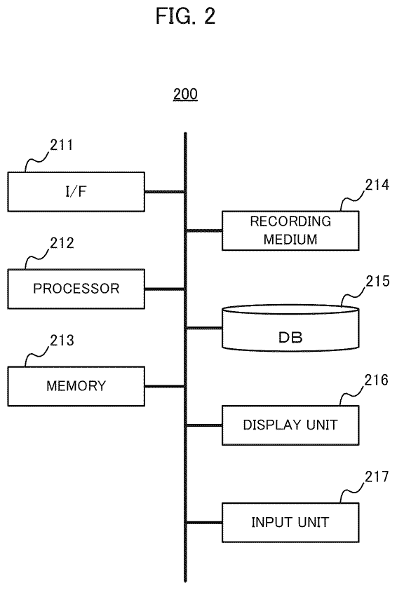

FIG. 2 is a block diagram illustrating a hardware configuration of the terminal device 200. The terminal device 200 is, for example, a PC, a tablet, or the like. As illustrated, the terminal device 200 includes an interface (I/F) 211, a processor 212, a memory 213, a recording medium 214, a database (DB) 215, a display unit 216, and an input unit 217.

The I/F 211 transmits data to and receives data from external devices. Specifically, the terminal device 200 receives the device information of the drone 5 from the drone 5 through the I/F 211. The terminal device 200 transmits the device information, the flight plan, the preparation state, and the like of the drone 5 to the server 100 through the I/F 211.

The processor 212 is a computer such as a CPU (Central Processing Unit), and controls the entire terminal device 200 by executing programs prepared in advance. The processor 212 may be a GPU (Graphics Processing Unit), a TPU (Tensor Processing Unit), a DSP (Digital Signal Processor), a MPU (Micro Processing Unit), a FPU (Floating point number Processing Unit), a PPU (Physics Processing Unit), a quantum processor, a FPGA (Field-Programmable Gate Array), or the like.

The memory 213 may be configured by a ROM (Read Only Memory), a RAM (Random Access Memory), and the like. The terminal device 200 may use the memory 213 as working memory during various processing operations by the processor 212.

The recording medium 214 is a non-volatile and non-temporary recording medium such as a disk-like recording medium or a semiconductor memory, and is configured to be detachable from the terminal device 200. The recording medium 214 records various programs executed by the processor 212. When the terminal device 200 executes various processes, the program recorded in the recording medium 214 is loaded into the memory 213 and executed by the processor 212.

The DB 215 stores data used by the terminal device 200 as well as data generated by the terminal device 200. Specifically, DB 215 stores the device information transmitted from the drone 5 and the flight plan, etc. input by the operator.

The display unit 216 is, for example, a liquid crystal display, and displays a screen for inputting the flight plan and the preparation state to the operator. The display unit 216 displays information transmitted from the server 100. The input unit 217 is, for example, an input device such as a keyboard, a mouse, or the like, and is used by the operator to input the flight plan or the preparation state.

### (Server)

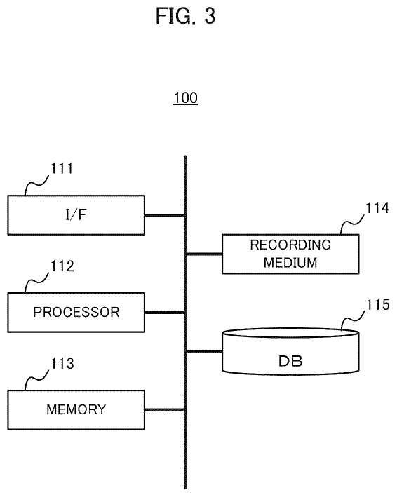

FIG. 3 is a block diagram illustrating a hardware configuration of the server 100. As illustrated, the server 100 includes an interface (I/F) 111, a processor 112, a memory 113, a recording medium 114, and a database (DB) 115.

The I/F 111 transmits data to and receives data from external devices. Specifically, the servers 100 receives information such as the device information, the flight plan, the preparation state, and the like of the drone 5 from the terminal device 200 through the I/F 111. The server 100 also transmits the modified flight plan to the terminal device 200 through the I/F 111.

The processor 112 is a computer such as a CPU, and controls the server 100 in its entirety by executing a program prepared in advance. Note that the processor 112 may be a GPU, a TPU, a quantum processor, a FPGA, or the like. The processor 112 performs the flight plan adjustment process, as will be described later.

The memory 113 is configured by a ROM, RAM, or the like. The memory 113 is also used as working memory during various processing operations by the processor 112.

The recording medium 114 is a non-volatile and non-temporary recording medium such as a disk-like recording medium or a semiconductor memory, and is configured to be detachable from the server 100. The recording medium 114 records various programs executed by the processor 112. When the server 100 executes various processes, the program recorded in the recording medium 114 is loaded into the memory 113 and executed by the processor 112.

The DB 115 stores data used by the servers 100. Specifically, the DB 115 stores the flight plans for the plurality of drones. In addition, the DB 115 stores the prediction model for predicting the available departure time. The server 100 may include an input unit such as a keyboard and a mouse, and a display unit such as a liquid crystal display, thereby to allow an administrator to give instructions or input.

### [Functional Configuration]

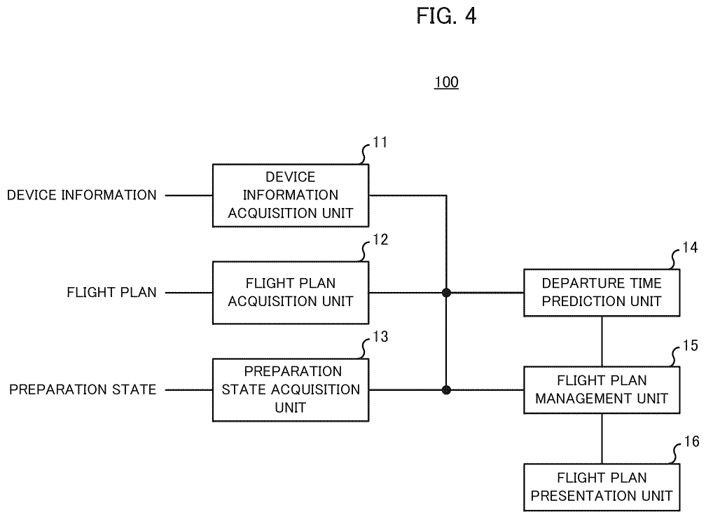

FIG. 4 is a block diagram illustrating a functional configuration of the server 100. The server 100 functionally includes a device information acquisition unit 11, a flight plan acquisition unit 12, a preparation state acquisition unit 13, a departure time prediction unit 14, a flight plan management unit 15, and a flight plan presentation unit 16.

The terminal device 200 acquires information from the drone and the operator. Specifically, the terminal device 200 acquires the device information transmitted by the drone, and the flight plan and the preparation state input by the operator, and transmits them to the server 100.

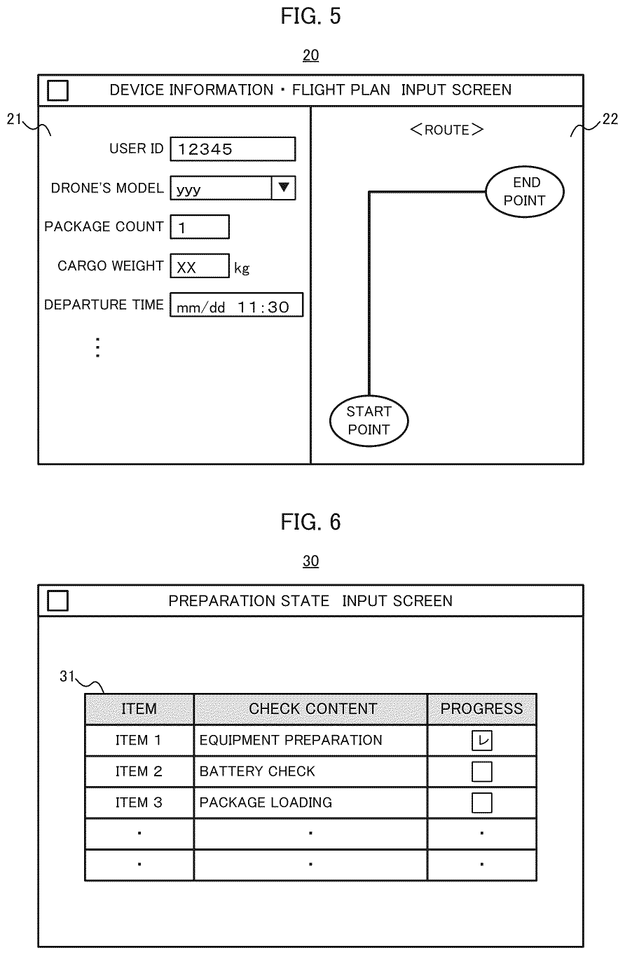

FIG. 5 and FIG. 6 are examples of the input screen of the terminal device 200. The terminal device 200 transmits the data input on the input screen to the server 100. FIG. 5 illustrates an example of the input screen for the device information and the flight plan. FIG. 5 displays basic information 21 and a route 22 on the input screen 20. The basic information 21 includes the device information and the flight plan of drones in addition to the user ID. The device information of the drone includes, for example, details such as the drone's model. In addition, the flight plan includes, for example, information such as the cargo to be loaded onto the drone and the drone's departure date and time. The terminal device 200 may accept the information received from the drone as device information, or may accept the input directly from the operator. The route 22 is the flight route of the drone. The route 22 is part of the flight plan. The terminal device 200 may accept the setting of the route 22 from the operator, or may generate an optimal flight route by accepting the departure point and the arrival point as settings from the operator.

FIG. 6 illustrates an example of an input screen of a preparation state. FIG. 6 displays a checklist 31 on an input screen 30. The checklist 31 includes items, check contents, and progress. The operator performs inspections and related tasks on the drone in accordance with the check contents of each item. Then, when the inspection and related tasks are completed, the operator marks the progress column of the corresponding item. Each time the operator updates the checklist 31, the terminal device 200 transmits the updated preparation state to the server 100.

Returning to FIG. 4, the server 100 receives the device information, the flight plan, and the preparation state from the terminal device 200. The device information acquisition unit 11 receives the device information from the terminal device 200. The flight plan acquisition unit 12 receives the flight plan from the terminal device 200. The preparation state acquisition unit 13 receives the preparation state from the terminal device 200.

The device information acquisition unit 11 acquires performance and specification information such as the maximum speed and maximum flight time of the drone, from a database or the like prepared in advance, based on the drone's model and other data included in the device information. Then, the device information acquisition unit 11 outputs the device information including the performance and specifications to the departure time prediction unit 14 and the flight plan management unit 15.

The flight plan acquisition unit 12 outputs the flight plan to the departure time prediction unit 14 and the flight plan management unit 15. The preparation state acquisition unit 13 outputs the preparation state to the departure time prediction unit 14 and the flight plan management unit 15.

The departure time prediction unit 14 acquires the device information from the device information acquisition unit 11, acquires the flight plan from the flight plan acquisition unit 12, and acquires the preparation state from the preparation state acquisition unit 13. Then, the departure time prediction unit 14 predicts the available departure time of the drone. Specifically, the departure time prediction unit 14 calculates the time required for the drone to depart (hereinafter, also referred to as “required time for departure”,) based on the preparation state. Then, the departure time prediction unit 14 predicts the available departure time of the drone by adding the required time for departure to the current time. The required time for departure (t) is calculated by the following equation using, for example, the progress (X) of each preparation, the required time (a) for each preparation, a margin time (tx), and a constant term (t0).

$$t = ( α 1 \times X 1 ) + ( α 2 \times X 2 ) + ( α 3 \times X 3 ) + tx + t 0 \qquad ( 1 )$$

X1 to X3 indicate the progress of each preparation item. For example, X1 indicates the progress of the equipment preparation. If the equipment preparation has been completed, “X1=0”; If the equipment preparation has not been completed, “X1=1.” X2 indicates the progress of the battery check. If the battery check has been completed, “X2=0”; If the battery check has not been completed, “X2=1.” X3 indicates the progress of cargo loading. If the cargo loading has been completed, “X3=0”; If the cargo loading has not been completed, “X3=1.” α1 to α3 indicate the required time for each preparation item. Note that α1 to α3, tx and t0 are determined based on past performance data. For example, the required time for each preparation item and the departure time are collected from past performance data, and the collected data is used as training data to train the model. Then, the departure time prediction unit 14 predicts α1 to α3, tx and t0 using the generated model. Then, the required time for departure is calculated.

Here, for example, only equipment preparation (X1) has been completed,
α1=−3, α2=−4, α3=−1
margin time (tx)=1
constant term (t0)=15

Then, the required time for departure (t) is calculated as follows.

$$t = ( - 3 \times 0 ) + ( - 4 \times 1 ) + ( - 1 \times 1 ) + 1 + 15 = 10 ( min )$$

The departure time prediction unit 14 predicts that the available departure time is the time obtained by adding the above-mentioned 10 minutes to the current time. Then, the departure time prediction unit 14 outputs the available departure time to the flight plan management unit 15.

The prediction method of the available departure time is not limited to the above method. For example, the departure time prediction unit 14 may predict the time required from the current state until all pre-flight preparations are completed, using HSMM (hidden semi-Markov models).

The flight plan management unit 15 acquires the device information from the device information acquisition unit 11, acquires the flight plan from the flight plan acquisition unit 12, acquires the preparation state from the preparation state acquisition unit 13, and acquires the available departure time from the departure time prediction unit 14. The flight plan management unit 15 determines whether the available departure time is within the range of the flight plan, based on the flight plan and available departure time. When the available departure time is not within the range of the flight plan, the flight plan management unit 15 adjusts the flight plan. Then, based on the adjusted flight plan (hereinafter, also referred to as “adjusted flight plan”), the flight plan management unit 15 updates the flight plan stored in the database 115. The flight plan management unit 15 outputs the adjusted flight plan to the operation plan presentation unit 16.

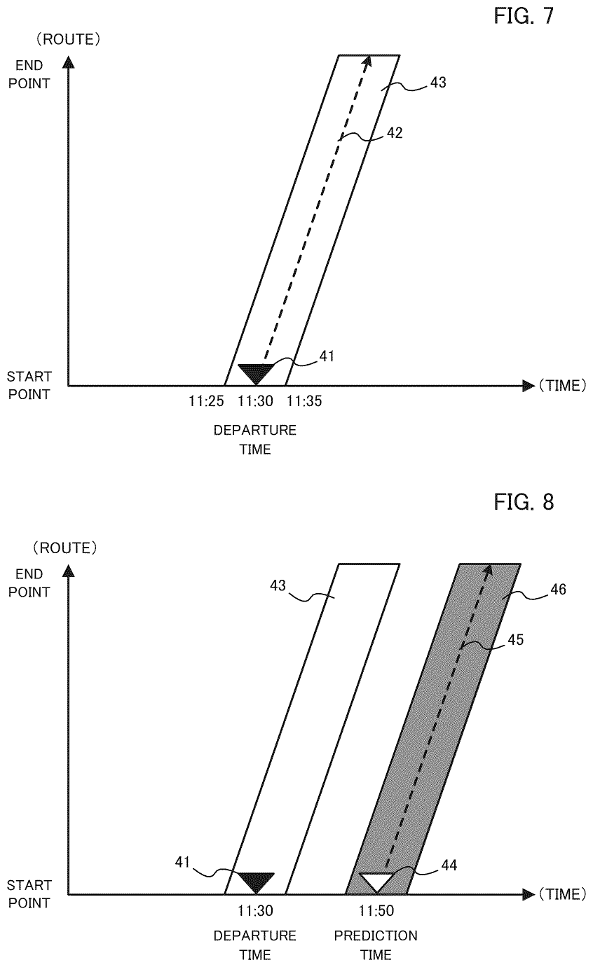

FIG. 7 to FIG. 10 illustrates examples of the adjustment of the flight plan by the flight plan management unit 15.

FIG. 7 illustrates an example of a flight plan. FIG. 7 includes a departure time 41, a spatiotemporal trajectory 42, and a flight planning space 43. The departure time 41 refers to the departure time of the drone defined in the flight plan. The spatiotemporal trajectory 42 represents the drone's path in space and time, i.e., the trajectory of the drone within the spatiotemporal domain. The spatiotemporal trajectory 42 is generated based on the geographic route from the start point to the end point, the departure time of the drone, and the speed of the drone. The flight planning space 43 is a space generated by adding a buffer (buffer zone) around the spatiotemporal trajectory 42. In FIG. 7, the departure time 41 of the drone is 11:30, and the buffer of 5 minutes is set before and after the departure time. The operator registers the flight planning space in the database 115 in advance, and prepares for flight so that the drone operates within the boundaries of the flight planning space.

FIG. 8 illustrates an example of the adjustment of the flight plan when a delay occurs in the flight plan. FIG. 8 includes a prediction time 44, a prediction spatiotemporal trajectory 45, and a prediction flight planning space 46 in addition to the departure time 41 and the operation planning space 43. The prediction time 44 refers to the available departure time predicted by the departure time prediction unit 14. The prediction spatiotemporal trajectory 45 refers to the spatiotemporal trajectory of the drone at the available departure time. The prediction spatiotemporal trajectory 45 is generated based on the geographic route from the start point to the end point, the available departure time of the drone, and the speed of the drone. The prediction flight planning space 46 is a space generated by adding a buffer around the prediction spatiotemporal trajectory 45. In FIG. 8, since the prediction time 44 is 11:50, the operator is unable to fly the drone within the range of the flight planning space 43. Therefore, the flight plan management unit 15 generates the prediction flight planning space 46 based on the prediction time 44. The prediction flight planning space 46 is an example of the adjusted flight plan described above.

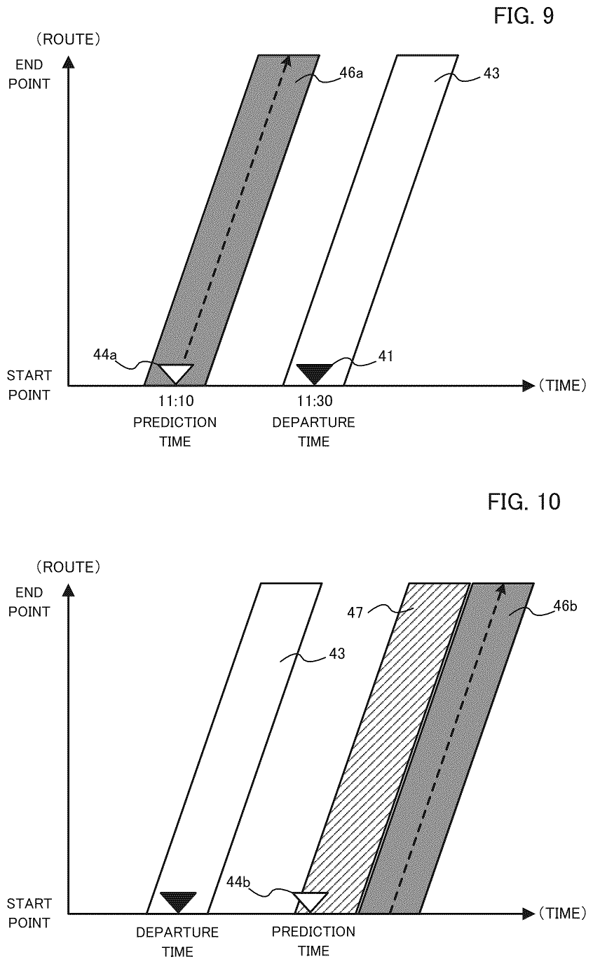

FIG. 9 illustrates an example of the adjustment of the flight plan when the flight plan is advanced. In FIG. 9, since a prediction time 44a is earlier than the departure time 41, it is possible to move up the drone flight. Therefore, the flight plan management unit 15 generates a prediction flight planning space 46a based on the prediction time 44a. The prediction flight planning space 46a is an example of the adjusted flight plan described above.

FIG. 10 illustrates an example of the adjustment of the flight plan when the available departure time overlaps with other flight plans. FIG. 10 includes other flight planning space 47 in addition to the departure time 41, the flight planning space 43, a prediction time 44b, and prediction flight planning space 46b. The other flight planning space 47 refers to a flight planning space that has been registered in the database 115 by another party. In FIG. 10, the prediction time 44b is included within the range of the other flight planning space 47. In such cases, the flight plan management unit 15 generates the prediction flight planning space 46b outside the range of the other flight planning space 47 so as to avoid conflicts with the other flight planning space 47. The prediction flight planning space 46b is an example of the adjusted flight plan described above.

Returning to FIG. 4, the flight plan presentation unit 16 generates display data based on the adjusted flight plan acquired from the flight plan management unit 15, and transmits the display data to the terminal device 200.

In the above-described configuration, the device information acquisition unit 11 and the flight plan acquisition unit 12 are examples of a device information acquisition means, the preparation state acquisition unit 13 is an example of a preparation state acquisition means, the departure time prediction unit 14 is an example of an available departure time prediction means, the flight plan management unit 15 and the flight plan presentation unit 16 are examples of a flight plan management means.

### Display Example

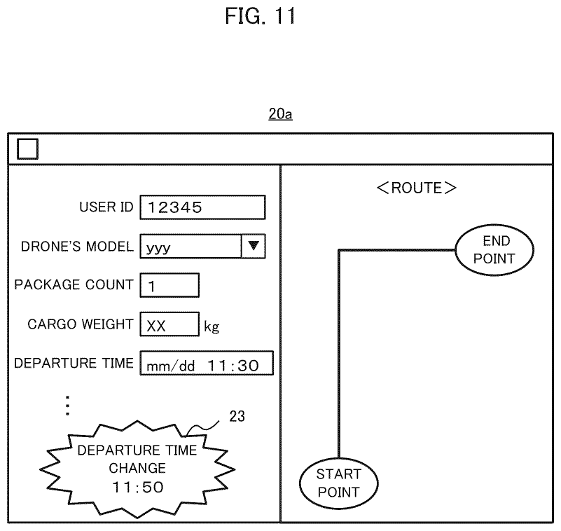

FIG. 11 illustrates a display example of the adjusted flight plan transmitted by the server 100. In this case, an adjusted time 23, which is the departure time after the adjustment, is displayed on the device information and flight plan input screen 20a. By looking at the adjusted time 23, the operator can recognize that a discrepancy has arisen between the original flight plan and the actual preparation state, and that the departure time of the drone has been changed.

### [Flight Plan Adjustment Process]

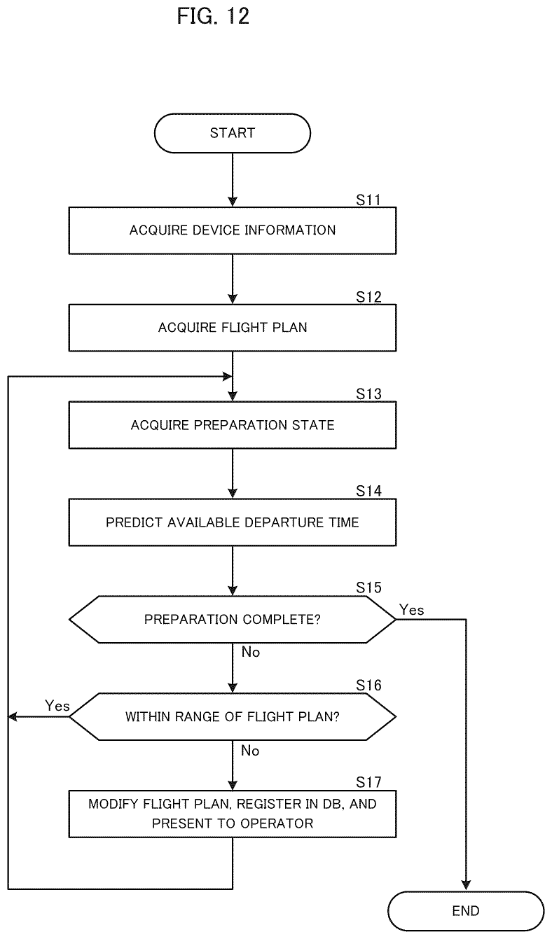

Next, the flight plan adjustment process will be described. FIG. 12 is a flowchart of the flight plan adjustment process by the server 100. This process is realized by the processor 112 illustrated in FIG. 3, which executes a corresponding program prepared in advance and operates as each element illustrated in FIG. 4.

First, the device information acquisition unit 11 acquires the device information from the terminal device 200, and outputs the device information to the departure time prediction unit 14 and the flight plan management unit 15 (step S11). The flight plan acquisition unit 12 acquires the flight plan from the terminal device 200, and outputs the flight plan to the departure time prediction unit 14 and the flight plan management unit 15 (step S12). The preparation state acquisition unit 13 acquires the preparation state from the terminal device 200, and outputs the preparation state to the departure time prediction unit 14 and the flight plan management unit 15 (step S13).

Next, the departure time prediction unit 14 predicts the available departure time of the drone based on the preparation state (step S14). The departure time prediction unit 14 outputs the predicted available departure time to the flight plan management unit 15.

Next, the flight plan management unit 15 determines whether all the pre-flight preparations by the operator have been completed (step S15). If the pre-flight preparations have not been completed (step S15: No), the flight plan management unit 15 determines, based on the flight plan and the available departure time, whether the available departure time is within the range of the flight plan (step S16). If the available departure time is within the range of the flight plan (step S16: Yes), the process returns to the step S13. On the other hand, if the available departure time is outside the range of the flight plan (step S16: No), the flight plan management unit 15 modifies the flight plan, and registers the modified flight plan in the database 115. Then, the flight plan presentation unit 16 presents the modified flight plan to the operator (step S17).

In this manner, the flight plan is modified as necessary until all pre-flight preparations by the operator are completed, and once pre-flight preparations are fully completed (step S15: Yes), the flight plan adjustment process ends.

### MODIFICATION

Next, modifications of the first example embodiment will be described.

The following modifications can be combined as appropriate and applied to the first embodiment.

### Modification 1

In the above-described first example embodiment, the management of the flight plan is for drones; however, the scope of management is not limited to drones, and may also include various unmanned aerial vehicles and unmanned transport vehicles that fly under external control.

### Modification 2

In the above-described first example embodiment, the server 100 updates the database 115 based on the adjusted flight plan, then transmits the adjusted flight plan to the terminal device 200, the application of the present disclosure is not limited thereto. For example, the server 100 may first transmits the adjusted flight plan to the terminal device 200 to request approval for the change in the flight plan, and only update the database 115 if the operator approves it.

### Modification 3

In the above-described first example embodiment, the server 100 adjusts the flight planning space by shifting the time to avoid conflicts with the other flight planning space; however, the adjustment method of the flight plan is not limited thereto. For example, the server 100 may generate a flight route that does not conflict with the flight routes of other flight plans and propose that route to the operator.

### Second Example Embodiment

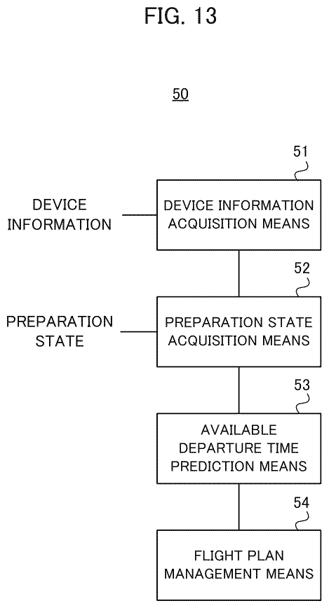

FIG. 13 is a block diagram illustrating a functional configuration of a flight plan management device 50 according to the second example embodiment. The flight plan management device 50 according to the second example embodiment includes a device information acquisition means 51, a preparation state acquisition means 52, an available departure time prediction means 53, and a flight plan management means 54.

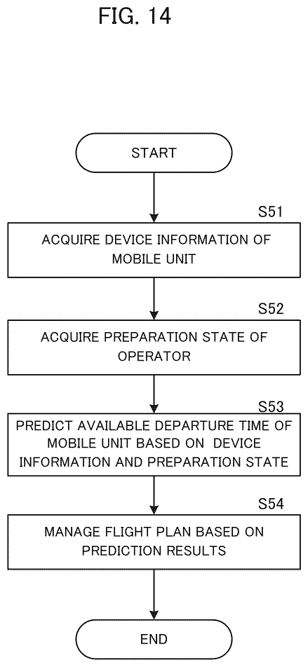

FIG. 14 is a flowchart of a process by the flight plan management device 50. The device information acquisition means 51 acquires device information of a mobile unit (step S51). The preparation state acquisition means 52 acquires a preparation state of an operator (step S52). The available departure time prediction means 53 predicts an available departure time of the mobile unit based on the device information and the preparation state (step S53). The flight plan management means 54 manages a flight plan based on prediction results (step S54).

According to the flight plan management device 50 of the second example embodiment, it is possible to adjust the spatiotemporal space to be used according to the pre-flight preparation conditions.

A part or all of the example embodiments described above may also be described as the following supplementary notes, but not limited thereto.

### (Supplementary Note 1)

A flight plan management device comprising:
a device information acquisition means configured to acquire device information of a mobile unit;
a preparation state acquisition means configured to acquire a preparation state of an operator;
an available departure time prediction means configured to predict an available departure time of the mobile unit based on the device information and the preparation state; and
a flight plan management means configured to manage a flight plan based on prediction results.

### (Supplementary Note 2)

The flight plan management device according to supplementary note 1, further comprising a scheduled departure time acquisition means configured to acquire a scheduled departure time of the mobile unit, wherein the flight plan management means compares the scheduled departure time with the available departure time and adjusts a departure time of the mobile unit

### (Supplementary Note 3)

The flight plan management device according to supplementary note 2, wherein the flight plan management means outputs adjustment results to a terminal device of the operator.

### (Supplementary Note 4)

The flight plan management device according to supplementary note 3, wherein the flight plan management means registers the adjustment results as the scheduled departure time when the operator approves the adjustment results.

### (Supplementary Note 5)

The flight plan management device according to supplementary note 1, wherein, when adjusting the flight plan of the mobile unit based on the available departure time, the flight plan management means adjusts the flight plan of the mobile unit so that the flight plan does not conflict with flight plans of other mobile units.

### (Supplementary Note 6)

The flight plan management device according to supplementary note 1, wherein, when adjusting the flight plan of the mobile unit based on the available departure time, the flight plan management means proposes an alternative route to the operator of the mobile unit so that the flight plan does not conflict with flight plans of other mobile units.

### (Supplementary Note 7)

A flight plan management method comprising:
acquiring device information of a mobile unit;
acquiring a preparation state of an operator;
predicting an available departure time of the mobile unit based on the device information and the preparation state; and
managing a flight plan based on prediction results.

### (Supplementary Note 8)

A recording medium storing a program, the program causing a computer to perform a process comprising:
acquiring device information of a mobile unit;
acquiring a preparation state of an operator;
predicting an available departure time of the mobile unit based on the device information and the preparation state; and
managing a flight plan based on prediction results.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

5 Drone
11 Device Information Acquisition Unit
12 Flight Plan Acquisition Unit
13 Preparation State Acquisition Unit
14 Departure Time Prediction Unit
15 Flight Plan Management Unit
16 Flight Plan Presentation Unit
100 Server
200 Terminal Device

What is claimed is:

1. A flight plan management device comprising:
at least one memory configured to store instructions; and
at least one processor configured to execute the instructions to:
acquire device information of a mobile unit;
acquire a preparation state of an operator;
predict an available departure time of the mobile unit based on the device information and the preparation state; and
manage a flight plan based on prediction results.

2. The flight plan management device according to claim 1, wherein the one or more processors acquire a scheduled departure time of the mobile unit, wherein the one or more processors compare the scheduled departure time with the available departure time and adjusts a departure time of the mobile unit.

3. The flight plan management device according to claim 2, wherein the one or more processors output adjustment results to a terminal device of the operator.

4. The flight plan management device according to claim 3, wherein the one or more processors register the adjustment results as the scheduled departure time when the operator approves the adjustment results.

5. The flight plan management device according to claim 1, wherein, when adjusting the flight plan of the mobile unit based on the available departure time, the one or more processors adjust the flight plan of the mobile unit so that the flight plan does not conflict with flight plans of other mobile units.

6. The flight plan management device according to claim 1, wherein, when adjusting the flight plan of the mobile unit based on the available departure time, the one or more processors propose an alternative route to the operator of the mobile unit so that the flight plan does not conflict with flight plans of other mobile units.

7. A flight plan management method comprising:
acquiring device information of a mobile unit;
acquiring a preparation state of an operator;
predicting an available departure time of the mobile unit based on the device information and the preparation state; and
managing a flight plan based on prediction results.

8. A non-transitory computer readable recording medium storing a program, the program causing a computer to perform a process comprising:
acquiring device information of a mobile unit;
acquiring a preparation state of an operator;
predicting an available departure time of the mobile unit based on the device information and the preparation state; and
managing a flight plan based on prediction results.
